(19) United States
(12) Patent Application Publication
(10) Pub. No.: US 2006/0086820 A1
(43) Pub. Date: Apr. 27, 2006

(54) Self-cleaning fluid delivery system

(76) Inventors: Bruce E. Byers, Howell, MI (US); Robert Christian, Clinton Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/259,298

(22) Filed: Oct. 26, 2005

Related U.S. Application Data
(60) Provisional application No. 60/622,382, filed on Oct. 27, 2004.

(51) Int. Cl. B05B 1/28; B05B 15/02; F23D 11/34

(52) U.S. Cl. 239/104; 239/106; 239/119

(57) ABSTRACT

A paint delivery system includes a self-cleaning filter. The system has a paint delivery device which is in fluid communication with a paint supply via a delivery line so as to be operable to selectively dispense a fluid therefrom. The system includes a purge line which may be selectively placed in fluid communication with a delivery line at a point downstream of the paint supply and upstream of the delivery device by the activation of a purge valve so that when the purge valve is activated the purge line diverts the fluid passing through the delivery line from passing through the delivery device so that the fluid passes through the purge line. The system includes a filter and a filter retainer which supports the filter. The retainer is disposed in the delivery line downstream of the paint supply and upstream of the delivery device and purge valve. The retainer is operable to displace the filter relative to the delivery line from a first, filtering position, wherein the filter traps particulate matter in paint, to a second, backwash position wherein a flow of fluid through the delivery line will clean the filter. Also disclosed are other applications for the filter system as well as methods for its use.

### RELATED APPLICATION

This application claims priority of U.S. Provisional Patent Application Ser. No. 60/622,382 filed Oct. 27, 2004, entitled “Self-Cleaning Fluid Delivery System.”

### FIELD OF THE INVENTION

This invention relates generally to fluid delivery systems such as paint delivery systems. More specifically, the invention relates to a fluid delivery system having a self-cleaning filter therein.

### BACKGROUND OF THE INVENTION

High-volume, production painting of items such as automobiles, appliances and the like is frequently accomplished by automated or semi-automated painting systems. These systems include a plurality of fluid delivery lines with associated valves and controllers operable to deliver one or more paint formulations from a central supply to a delivery device such as a spray nozzle or bell. In some instances, the systems are operable to periodically purge the paint delivery lines with a purging composition, and such purging is often carried out when the type of paint being delivered by the system is changed. Automated fluid delivery systems are also used to deliver adhesives as well as process chemicals.

The complexity of such automated fluid delivery systems makes them sensitive to particulate contamination in the fluid stream, since such contamination could block valves, sensors, regulators, nozzles and other critical components of the system. Typically, such fluid delivery systems will include one or more filters. The filters are generally placed well upstream of the delivery device, typically in close proximity to the source of fluid, and operate to trap sediment and other particulate matter which may be present in the bulk fluid. However, further sediments may be generated downstream of such filters. For example, the material forming the fluid delivery lines may spall, or otherwise generate particulate matter. Also, in paint delivery systems, paint residues may build up on delivery lines over time. Such residues are often not removed by purging or cleaning, but they can break loose in the use of the system and generate particulate contamination. Such downstream particles can be very damaging to critical valves, sensors, regulators, nozzles, and other structures of paint delivery systems. Heretofore, it has not been practical to include downstream filters in paint delivery systems, since cleaning and/or replacement of filter elements thus disposed can result in significant expense and downtime of critical equipment. Hence, the art has heretofore relied solely upon periodic purge cycles to clean downstream portions of paint delivery systems.

As will be explained hereinbelow, the present invention provides a self-cleaning filter assembly for paint, adhesive or other fluid delivery systems. When employed in a paint delivery system, the filter assembly of the present invention eliminates defects in paint finishes resultant from contaminants which are in the paint and/or generated internally by the paint delivery system itself. The filter assembly of the present invention is operable to trap downstream particulate contamination at a point just before a spray nozzle thereby preventing damage to that device. Furthermore, the filter assembly of the present invention is self cleaning and its operational cycle may be readily integrated with operation of a line purge system. These and other details of the present invention will be apparent from the drawings and description hereinbelow.

### BRIEF DESCRIPTION OF THE INVENTION

Disclosed herein is a paint delivery system. The system includes a paint delivery device in fluid communication with a paint supply via a delivery line. The paint delivery device is operable to selectively dispense a fluid therefrom. The system includes a purge line which may be selectively placed in fluid communication with the delivery line at a point downstream of the paint supply and upstream of the delivery device, by activation of a purge valve so that when the purge valve is activated the purge line diverts a fluid passing through the delivery line from passing through the delivery device so that the fluid passes through the purge line. The system further includes a filter which is supported by a filter retainer. The filter retainer is disposed in the delivery line downstream of the paint supply and upstream of the delivery device and purge valve. The retainer is operable to displace the filter relative to the delivery line from a first, filtering position wherein the filter traps particulate matter in the paint, to a second, backwash position, wherein a flow of fluid through the delivery line will clean the filter. The system may further include a purge fluid supply which can be selectively placed in fluid communication with the delivery line. The purge fluid supply is activatable to dispense a purge fluid into the delivery line.

In some embodiments, the filter retainer is operable to rotate the filter approximately 180 degrees relative to the direction of flow of the fluid through the delivery line. In other embodiments, the filter retainer is operable to displace the filter from the delivery line to the purge line. The system may also include a controller which controls the operation of the purge valve and the filter retainer so that when the purge valve is activated the retainer displaces the filter to the second, backwash position. The retainer may be configured to allow the filter to be removed from the system for replacement, and in some instances, such removal may be accomplished while the system is in operation.

Also disclosed is use of the present invention in other fluid delivery systems including adhesive delivery systems, other liquid delivery systems, gas delivery systems, and the like. Also disclosed is a method for operating a fluid delivery system wherein the system may be selectably cleaned during its operational cycles.

### BRIEF DESCRIPTION OF THE DRAWINGS

FIG. 1 is a schematic depiction of a paint delivery system structured in accord with the principles of the present invention;

FIG. 2 is a top plan view of a filter retainer which may be used in the practice of the present invention;

FIG. 3 is a cross-sectional view of a portion of a fluid delivery system including the filter retainer of FIG. 2, a fluid delivery line, and a purge line; and

FIG. 4 is a top plan view of another embodiment of filter retainer of the present invention.

### DETAILED DESCRIPTION OF THE INVENTION

The present invention will be explained with reference to a paint delivery system; but it is to be understood that in accord with the present invention, a paint delivery system or the like includes a filter. The filter is supported by a filter retainer preferably at a point just upstream of a spray nozzle or other fluid delivery device. The filter operates to trap particulates in the fluid stream, and the filter retainer is further operable to displace the filter relative to the fluid flow streams from a first position in which it operates to trap particulates to a second, backwash position in which a flow of fluid through the fluid delivery line will clean the filter.

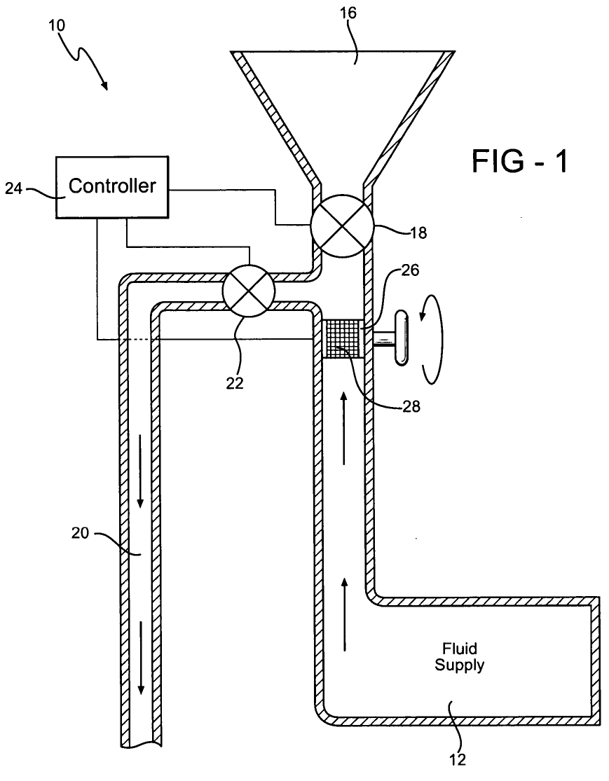

Referring now to FIG. 1, there is shown one embodiment of the system of the present invention as incorporated into a paint delivery system. FIG. 1 illustrates a paint delivery system 10 which operates to deliver paint from a fluid supply 12, via a delivery line 14, to a delivery device such as a device generally known in the art as a bell 16. As is understood in the art, the fluid supply may have pumps and controllers associated therewith, and such elements are not shown in this figure. As is conventional in the art, a delivery valve 18 is disposed in the delivery line 14 and operates to allow the selectable delivery of paint through the delivery device 16.

As is also known in the art, the paint delivery system 10 of FIG. 1 includes a purge line 20 which is in fluid communication with the delivery line 14 via a purge valve 22. In the FIG. 1 embodiment, a controller 24 is in operative communication with the delivery valve 18 and purge valve 22.

In the operation of the system of FIG. 1, the fluid supply 12 is pressurized via a pump or the like, and paint is delivered via the delivery device 16 when the delivery valve 18 is open. Closing of the delivery valve 18 terminates the flow of paint through the delivery device 16. When it is necessary to purge the system, the purge valve 22 is opened, and the delivery valve 18 is maintained in its closed state. Under such circumstances, fluid will pass from the fluid supply 12 through the purge valve 22 and exit via the purge line 20. As is noted above, and as is known in the art, purging is typically carried out when paint color or type is changed and/or whenever it is necessary to clean debris from the delivery lines. In some instances, specialized purge fluids may be run through the purge line as part of the purging process.

In accord with the present invention, a filter assembly comprised of a filter retainer 26 and a filter 28 is disposed in the delivery line downstream of the fluid supply 12, and upstream of the delivery device 16. As will be seen from FIG. 1, the filter assembly is positioned so that the filter 28 will trap a majority of particles in the delivery stream prior to the point at which they encounter the delivery valve 18 and delivery device 16. It is a further feature of the present invention that the filter retainer 26 is configured and operable so as to be capable of displacing the filter 28 relative to the delivery line, from a first, filtering position wherein particulates in the fluid stream are retained by the filter to a second, backwash position wherein a flow of fluid through the delivery line will clean the filter. In the instance of FIG. 1, the filter retainer 26 is rotatable within the delivery line 14 so as to reverse the position of the filter 28 relative to a flow of fluid through the delivery line. When the filter 28 is so reversed, particulate matter which is trapped in the filter will be backwashed therefrom.

The filter assembly of the present invention can operate in conjunction with the purge cycle of the paint system. In the FIG. 1 embodiment, the delivery valve 18 is closed, the position of the filter 28 is reversed, and the purge valve 22 is open. This will cause fluid to flow from the fluid supply 12 thereby backwashing the filter 28. Debris cleaned from the filter 28 will then pass through the purge valve 22 and be removed by the purge line 20. Once the purge cycle is complete, the purge valve 22 is closed, and the filter 26 may be returned to its service position. Alternatively, and depending upon the nature of the filter 28, the filter may be left in its initially reversed position since all debris will be removed therefrom. Operation of the purge valve 22, filter retainer 26 and delivery valve 18 may be controlled by the controller 24.

The nature of the filter 28 will depend upon the characteristics of the fluid being filtered, and the type of debris which is anticipated to be found in the fluid stream. Accordingly, the filter 28 may comprise a relatively simple screen, a membrane, a depth filter such as a bed filter, or any other filter known in the art.

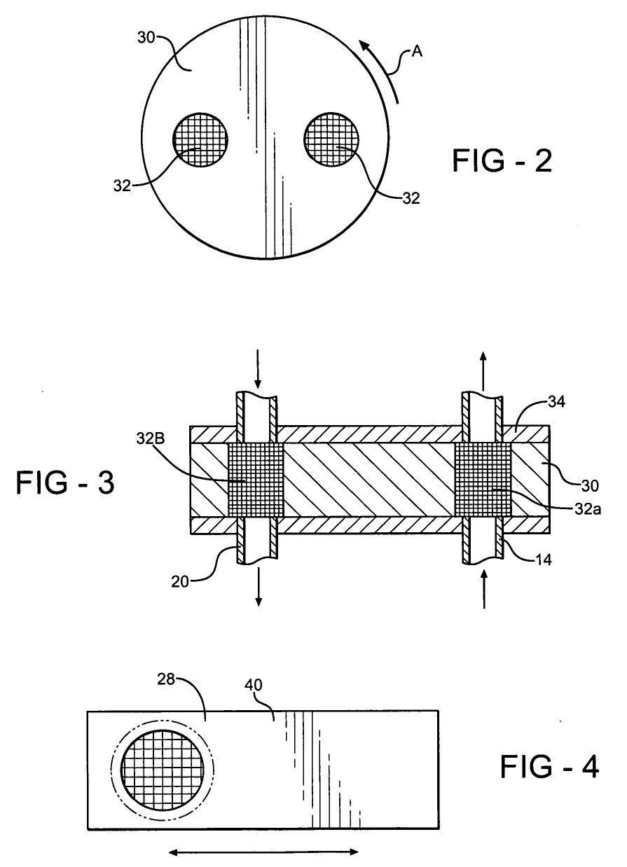

The present invention may be implemented in other configurations. While FIG. 1 shows a filter retainer which rotates relative to the direction of the fluid stream, filters may be retained in a retainer which translates a filter relative to a fluid stream. Referring now to FIG. 2, there is shown a top, plan view of a filter retainer 30 having two filter bodies 32 supported therein. The retainer 30 is supported so as to be rotatable in the direction of the arrow A so as to move the filters 32.

Referring now to FIG. 3, there is shown a side, cutaway view of a portion of a fluid delivery system incorporating the filter retainer 30 of FIG. 2. As shown in the figure, the filter retainer 30 is supported by a housing 34 which engages the fluid delivery line 14 and purge line 20 of a paint delivery system. In this manner, a first filter body 32a is disposed in a fluid stream passing through the delivery line 14 and operates to trap debris therein. As shown in FIG. 3, a second filter body 32 is in the purge stream so that when the system is being purged, fluid flowing through the purge line 20 will backwash that filter. In the operation of the FIG. 3 system, the filter retainer 30 is rotated so as to move the filter 32 from the delivery line 14 to the purge line 20 thereby placing it in a backwash position. In a two filter system such as that of FIG. 3, this action will also translate the second filter 32b from the purge line to the delivery line thereby placing it back in service. It will be clear to one of skill in the art that systems of this type may be further modified to include a larger or smaller number of filters. For example, the FIG. 2/3 embodiment may incorporate only a single filter which is moved from the delivery line 14 to the purge line 20; or, it may include more than two filters, and may be operational in conjunction with a plurality of delivery and purge lines, or it may be operational in conjunction with only one purge and delivery line with the unused filters being maintained as backup filters, or with those filters being placed in service or replacement positions. For example, in the FIG. 3 embodiment, the retainer 30 may be configured to hold a plurality of filters, and the housing 34 may be configured to allow the removal and replacement of at least one of the filters while the system is operational.

Yet other configurations of filter retainer may be implemented. For example, FIG. 4 shows a filter retainer 40 which is operable to support a single filter 28 and translate that filter in a back-and-forth direction between a delivery line and a purge line. Yet other embodiments of filter and retainer may be configured in accord with the present invention.

It is to be understood that the present invention has been explained primarily with reference to a paint delivery system. However, the principles of the present invention may be utilized in conjunction with other fluid delivery systems.

For example, the system of the present invention may be utilized to deliver high viscosity materials such as adhesives, sealants, polymeric compositions and the like. In such instances, the filter will be configured to accommodate the high viscosity fluid. As such, the filter will typically have a coarser porosity and a higher surface area. Also, the fluid supply will be configured to operate at a relatively high pressure. In other instances, the system of the present invention may be utilized to filter and deliver other fluids including food products, pharmaceuticals, agricultural chemicals and the like. The filter system of the present invention may also be incorporated into other, more complex fluid handling systems such as chemical reactors, chemical processing equipment, food processing equipment, and the like.

Such embodiments and applications will be readily apparent to those of skill in the art in view of the teaching presented herein. The drawings, discussion and description are illustrative of specific embodiments but are not meant to be limitations upon the practice of the present invention. It is the following claims, including all equivalents, which define the scope of the invention.

1. A paint delivery system, said paint delivery system comprising:
a paint delivery device which is in fluid communication with a paint supply via a delivery line, and is operable to selectively dispense a fluid therefrom;
a purge line which may be selectively placed in fluid communication with the delivery line at a point downstream of the paint supply and upstream of the delivery device by the activation of a purge valve, so that when said purge valve is activated, said purge line diverts a fluid passing through said delivery line from passing through said delivery device so that said fluid passes through the purge line;
a filter; and
a filter retainer which supports the filter, said filter retainer being disposed in the delivery line, downstream of said paint supply and upstream of said delivery device and said purge valve, said retainer being operable to displace the filter relative to the delivery line, from a first, filtering position wherein the filter traps particulate matter in said paint, to a second, backwash position wherein a flow of fluid through said delivery line will clean the filter.

2. The system of claim 1, further including a purge fluid supply which may be selectively placed in fluid communication with said delivery line, said purge fluid supply being activatable to dispense a purge fluid into said delivery line.

3. The fluid delivery system of claim 1, wherein said filter retainer is operable to rotate the filter approximately 180 degrees relative to a direction of flow of fluid through the delivery line.

4. The system of claim 1, wherein said retainer is operable to displace the filter from the delivery line to the purge line.

5. The system of claim 1, further including a controller which controls the operation of the purge valve wherein the controller is further operable to control the operation of the filter retainer so that when the purge valve is activated, the retainer displaces the filter to the second, backwash position.

6. The fluid delivery system of claim 1, wherein said filter comprises a member selected from the group consisting of: membranes, screens, depth filters, and combinations thereof.

7. The fluid delivery system of claim 1, wherein said filter is a screen.

8. The fluid delivery system of claim 1, wherein said retainer is further operable to allow the filter to be removed from the system for replacement.

9. The fluid delivery system of claim 8 wherein said retainer is operable to allow the filter to be removed from the system without interrupting the operation of the system with regard to the delivery of fluid and/or purge operations.

10. The system of claim 1, wherein said retainer is further operable to retain a plurality of filters.

11. In a fluid delivery system which includes a delivery device which is in fluid communication with a fluid supply via a delivery line, and is operable to selectively dispense a fluid therefrom, and a purge line which may be selectively placed in fluid communication with said delivery line, at a point downstream of said fluid supply and upstream of said delivery device by the activation of a purge valve, so as to divert a flow of fluid passing through said delivery line from said delivery device and through said purge line; wherein the improvement comprises:
a filter which is supported by a filter retainer which is disposed in said delivery line downstream of said fluid supply and upstream of said delivery device and said purge valve, said retainer being operable to displace the filter relative to the delivery line, from a first, filtering position, wherein particulates in said fluid stream are retained by said filter, to a second, backwash position, wherein a flow of fluid through said delivery line will clean the filter.

12. The fluid delivery system of claim 11, wherein said system further includes a purge fluid supply which may be selectively placed in fluid communication with the delivery line, said purge fluid supply being activatable to dispense a purge fluid into said delivery line.

13. The fluid delivery system of claim 11, wherein said filter retainer is operable to locate the filter approximately 180 degrees relative to a direction of flow of fluid through the delivery line.

14. A method of operating a paint delivery system, said paint delivery system comprising:
a paint delivery device which is in fluid communication with a paint supply via a delivery line, and is operable to selectively dispense a fluid therefrom;
a purge line which may be selectively placed in fluid communication with the delivery line at a point downstream of the paint supply and upstream of the delivery device by the activation of a purge valve, so that when said purge valve is activated said purge line diverts a fluid passing through said delivery line from passing through said delivery device so that said fluid passes through the purge line;
a filter; and
a filter retainer which supports the filter, said filter retainer being disposed in the delivery line, downstream of said paint supply and upstream of said delivery device and said purge valve, said retainer being operable to displace the filter relative to the delivery line, from a first, filtering position wherein the filter traps particulate matter in said paint, to a second, backwash position wherein a flow of fluid through said delivery line will clean the filter; and
operating said system in a first mode wherein said purge valve is closed, said retainer retains the filter in the first, filtering position, and fluid passes from the paint supply, through the filter and to the delivery device wherein any particulate matter which is in the paint is trapped by the filter;
ceasing the operation of the system in the first mode;
operating the system in a second mode, wherein the purge valve is activated so as to divert fluid passing through the delivery line from passing through the delivery device so that the fluid passes through the purge line; and
operating the filter retainer so as to put the filter in the second, backwash position so that the flow of fluid through the delivery line will clean the filter.

15. A self-cleaning filter system, said system comprising:
a fluid delivery line;
a filter;
a filter retainer which supports said filter, said filter retainer being disposed in said delivery line, said retainer being operable to displace the filter, relative to the delivery line, from a first, filtering, position wherein the filter traps particles from a fluid flowing through said delivery line, to a second, backwash position, wherein said fluid flowing through said delivery line will clean said filter.
